(19) United States
(12) Patent Application Publication
(10) Pub. No.: US 2017/0159631 A1
(43) Pub. Date: Jun. 8, 2017

(54) Heavy Equipment Remote Starting System

(71) Applicant: Scott Delbert Vonasek, East Grand Forks, MN (US)

(72) Inventor: Scott Delbert Vonasek, East Grand Forks, MN (US)

(21) Appl. No.: 14/957,792

(22) Filed: Dec. 3, 2015

(51) Int. Cl. F02N 11/08; G01S 19/10; H04L 29/08

(52) U.S. Cl. CPC F02N 11/0807; H04L 67/02; H04L 67/12; G01S 19/10; H04W 80/04

(57) ABSTRACT

An apparatus and method to remotely start the ignition system of a heavy vehicle is disclosed. The apparatus is comprised of a wireless control device that is operably coupled to the ignition system of the vehicle that could wirelessly communicate with a smart phone through an Internet protocol network. The smart phone is capable of storing a set of instructions, which, when executed by the processing unit of smart phone, allows the user to select the vehicle and send the instruction to control device in the vehicle to start the ignition. The invention allows the user to select the vehicle based on its location using a GPS system.

### CROSS REFERENCE TO RELATED APPLICATION

Not Applicable

### FEDERALLY SPONSORED RESEARCH AND DEVELOPMENT

Not Applicable

### MICROFICHE APPENDIX

Not Applicable

### BACKGROUND OF THE INVENTION

(1) Field of Invention

The Present invention generally relates to an apparatus and method for use in the remote operation of a vehicle ignition system. In particular, the invention relates to the remote starting of a heavy vehicle ignition system.

(2) Background of Invention

Vehicle remote starters have been successfully used in light vehicles for remote the operation of the vehicle's ignition system. These have been particularly useful in cold climates, wherein the vehicle takes a good amount of time to start and the engine temperature to reach operable temperature condition. Prior art discloses many advances in vehicle remote starters, such as U.S. Pat. No. 8,489,085, issued to “Dei Headquarters, Inc.,” which discloses a system and method for a remote vehicle starter with an advanced dynamic scheduling system that utilizes a cellular telephone, interfaces with standard scheduling software, and communicates through a wireless telecommunication network with a vehicle to send vehicle remote start signal. Another, U.S. Pat. No. 6,028,372, issued to “Designtech International, Inc.,” discloses a control operation for a remote vehicle starter that allows a daily automatic setting to activate the remote vehicle starter. Another, U.S. Pat. No. 7,532,959, issued to “Dei Headquarters, Inc.,” discloses a remote start method and apparatus for an engine that is coupled to a manual transmission. Another, U.S. Pat. No. 8,751,065, issued to “Denso Corporation,” discloses a vehicle control system that is configured to wirelessly communicate with a mobile device that is configured to enable the ignition system of vehicle.

Although many advances have been made in developing remote vehicle starters for lightweight vehicles, the prior art discloses no significant attempt in developing remote starters for heavy vehicle, such as tractors. Heavy vehicles require significant time to warm up, which may consume working hours of the operator. Thus, a need is appreciated for a remote ignition starter for heavy vehicles that allows the user to start the equipment prior to showing up on job site, therefore saving time and money by not having to wait for the equipment to warm up.

### SUMMARY OF THE INVENTION

The present invention, therefore, has as its principal objective to provide a remote vehicle start apparatus for a heavy vehicle.

Another objective of the present invention is to provide a method to use the aforesaid apparatus for the remote operation of the ignition system of a heavy vehicle.

An additional objective is that the apparatus could be operated at any range from the vehicle.

Yet another objective is that the apparatus is simple to use.

Certain embodiments of current invention provide an apparatus and method for remotely starting the ignition of a heavy vehicle, such as, but not limited to, a tractor, a truck, etc. The apparatus is comprised of a wireless control device that is operably coupled to the ignition system of the vehicle. The device could wirelessly communicate with a remote device, such as, but not limited to, a smart phone, through an Internet protocol network. The smart phone could be capable of storing a set of instructions, which, when executed by the processing unit of smart phone, allow the user to select the vehicle and send an instruction to start the ignition of vehicle through an Internet network.

In a preferred embodiment, the current invention provides a method to locate the position of at least one vehicle and select the vehicle based on its location. Or, the method may allow the user to select a vehicle from a group of vehicles.

In addition to the various objectives and advantages of the present invention, described with some degree of specificity above, it should be obvious that additional objectives and advantages of the present invention will become more readily apparent to those persons who are skilled in the relevant art from the following more detailed description of the invention, particularly when such description is taken in conjunction with the attached drawing figures.

### BRIEF DESCRIPTION OF THE DRAWINGS

The drawings constitute a part of this specification, and include exemplary embodiments to the invention, which may be embodied in various forms. It is to be understood that, in some instances, various aspects of the invention may be shown exaggerated or enlarged to facilitate an understanding of the invention.

FIG. 1 depicts steps taken to start ignition system of a vehicle remotely.

FIG. 2 depicts a remote communication device.

### DETAIL DESCRIPTION OF THE INVENTION

As discussed above, embodiments of the present disclosure relate to an apparatus and method to remotely start an ignition system of heavy vehicle.

Before explaining at least one embodiment of the invention in detail, it is to be understood that the invention is not limited in its application to the details of construction and the arrangements of the components set forth in the following description. The invention is capable of other embodiments, and of being practiced and carried out in various ways. Also, it is to be understood that the phraseology and terminology employed herein are for the purpose of description, and should not be regarded as limiting.

As a preface to the detailed description, it should be noted that, as used in this specification and the appended claims, the singular forms “a”, “an” and “the” include plural referents, unless the context clearly dictates otherwise.

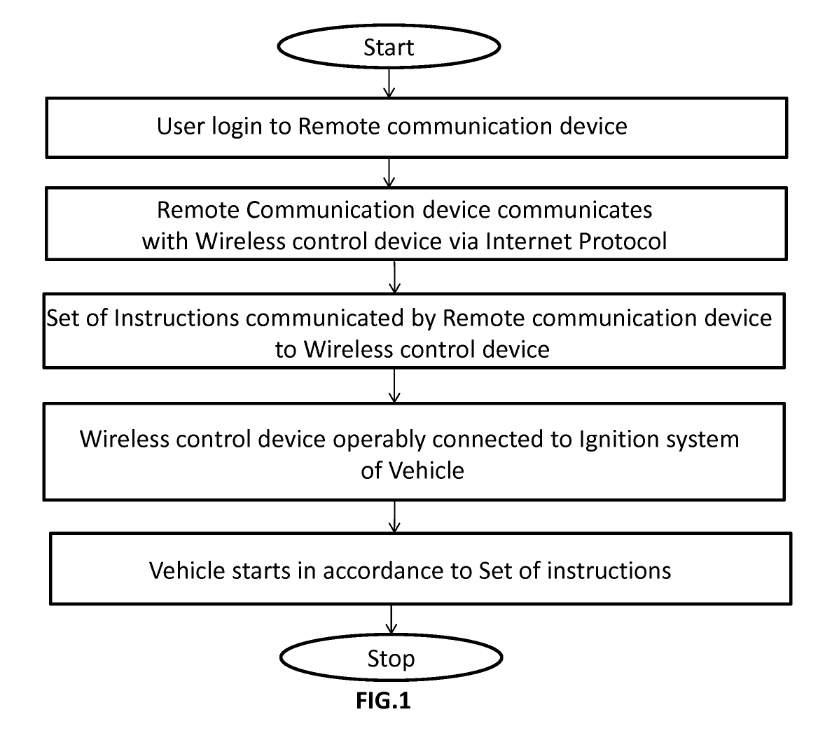

Referring to FIG. 1 shows steps taken to start ignition system of a vehicle remotely. In the first step, the user logs into the remote communication device and searches for a vehicles and its location. In second step, the remote communication device remotely connects to wireless control device via Internet. In third step, the set of instructions stored in readable memory of the remote communication device are communicated to the wireless control device. In the fourth step, the wireless control device checks a no. of equipments installed in the vehicle for example position of brake pedal, position of gear, level of engine oil etc. in accordance to the set of instructions. The position and level of various equipments are known with the help of a no. of sensors for example position sensor, level sensor, level indicator etc. In the fifth step, the ignition system is started.

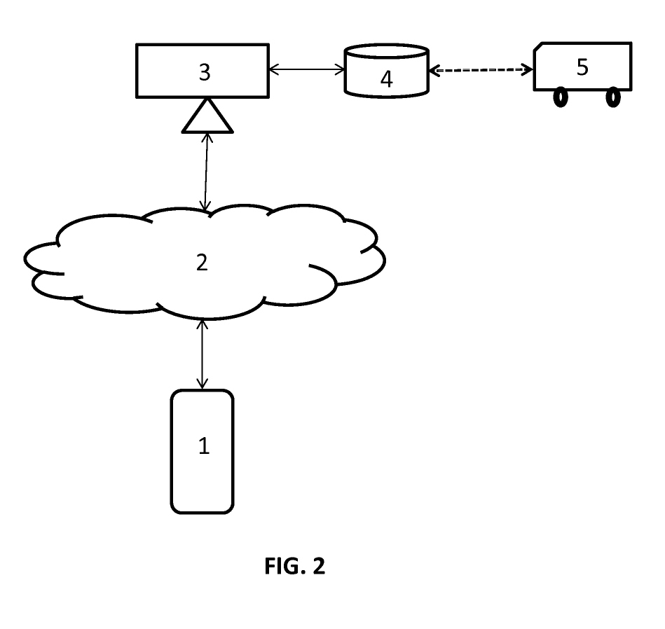

Similarly, referring to FIG. 2 shows a remote communication device (1) that has a computing system and is connected with server (2) via internet. The wireless control device (3) is also connected to the server. The vehicle's location is also provided to the user by a remote transmitter (4) installed within the vehicle. Accordingly, the user logs into the remote communication device and enables it to communicate a set of instructions to the remote control device that is operably connected to the ignition system of a vehicle (5). The ignition system is turned on remotely.

The present invention is a remote vehicle ignition starting apparatus and a method to operate the apparatus to remotely start a heavy vehicle, such as a truck, bus, tractor, etc. The invention is particularly advantageous in cold climates, wherein the present invention may allow warming the vehicle's engine to an operable temperature without the need for an operator to be present in or near the vehicle. This could save the operator time; otherwise the operator has to wait for the engine to warm-up. Thus, the present invention may allow an increase in productivity, and also save money.

Heavy vehicles are particularly difficult to start in cold climates, and the operator spends significant time in the morning to start the engine before the operator can perform their assigned work. Using the invention, the operator may send an ignition signal before reaching the worksite, such as, before leaving the home to go to the worksite. The operator, from his previous experience of starting the vehicle, may estimate the time required for starting the vehicle, and, accordingly, send the instruction to start the engine.

The apparatus is comprised of a wireless control device that is operably coupled to the ignition system of the vehicle. The control device could start the ignition automatically, without any intervention of operator or the vehicle's key inserted into the ignition. The control device could have the ability to check the status of the vehicle's transmission, such as the position of the gear or the position of the braking pad, or any other precaution that is to be observed before starting the engine of the vehicle. The control device could be powered by the electrical system of the vehicle, and could wirelessly communicate with a remote device. The remote device could be any computing device with Internet connectivity, such as a laptop, desktop, cellular phone, notepad, etc. Preferably, the remote device could be a smart phone. The control device in the vehicle could communicate to the smart phone through an Internet protocol, such as GPRS, 3G, Wi-Fi, etc. Use of Internet connectivity allows the user to operate the ignition system of the vehicle at any distance from the vehicle.

The present invention provides a set of instructions contained in the remote device, which, when executed by the processing unit of the remote device, allows the user to select the vehicle and send the instruction to the control device to start the ignition of the vehicle. The present invention provides a method to use the apparatus for the remote ignition of a vehicle. The method allows the user to locate the position of the vehicle using GPS. The vehicle could then be started by using the apparatus of present invention. For example, a user that has three identical tractors standing in different locations, such as one in the field, one on the farmyard, and another in a different field, could locate the position of each tractor on the display screen of the smart phone and choose the tractor based on its location. Thus, the user may start the vehicle without remembering its unique ID or name. The smart phone may incorporate a GPS receiver to locate the position of vehicle, wherein the control unit in the vehicle may contain the GPS transmitter. Besides the use of GPS, the invention may further use other methods to locate the object, such as using cellular phone towers, or any other methods obvious to a skilled person.

In other embodiment, the set of instructions contained in the mobile device may allow the user to select the vehicle from a group of vehicles shown on the display screen. The user may operate more than one vehicle using a single mobile device.

The control device in the vehicle may further have sensors to detect the engine oil level and communicate the same to the remote device. This could allow the user to check the oil level before sending the instruction to start the engine. Such a mechanism could prevent any damage to the vehicle and improve productivity.

A server may control the communication between the control device in the vehicle and the remote device. Such servers may also provide an interface for operating the control device, for example, a website, etc. Such method could allow the user to operate the vehicle using any remote device, such as a laptop, desktop, or a smart phone. Access to the servers could be monitored, and the user may be charged for using the services. This makes the invention commercially advantageous.

Those skilled in the art should appreciate that they can readily use the disclosed conception and specific embodiment as a basis for designing or modifying other structures for carrying out the same purposes of the present invention, and that such other structures do not depart from the spirit and scope of the invention in its broadest form.

I claim:

1. An apparatus for remote operation of an ignition system of a vehicle, comprising:
a. a wireless control device, wherein said wireless control device is operably coupled to said ignition system of said vehicle; and
b. a computing system, wherein said computing system is implemented on a remote communication device.

2. An apparatus for remote operation of an ignition system of a vehicle according to claim 1, wherein said vehicle is selected from group comprising truck, bus, tractor or any other heavy vehicle.

3. An apparatus for remote operation of an ignition system of a vehicle according to claim 1, wherein said remote communication device is selected from group comprising smartphone, tablet, laptop, desktop or any other PDA.

4. An apparatus for remote operation of an ignition system of a vehicle according to claim 1, wherein said remote communication device comprises a display screen; a processing unit; and, a computer-readable data carrier.

5. An apparatus for remote operation of an ignition system of a vehicle according to claim 4, wherein said computer-readable data carrier stores a plurality of instructions.

6. An apparatus for remote operation of an ignition system of a vehicle according to claim 5, wherein a first set of instructions out of said plurality of instructions enables internet connectivity of said remote communication device to a server.

7. An apparatus for remote operation of an ignition system of a vehicle according to claim 1, said remote communication device communicates with said wireless control device using an internet protocol.

8. An apparatus for remote operation of an ignition system of a vehicle according to claim 7, wherein said internet protocol includes Wi-fi, GPRS or 3G.

9. An apparatus for remote operation of an ignition system of a vehicle according to claim 7, said remote communication device enables a user to send a second set of instructions to said wireless control device to start said ignition system of said vehicle.

10. An apparatus for remote operation of an ignition system of a vehicle according to claim 9, wherein said wireless communication device validates a plurality of equipments in accordance to said second set of instructions before starting said ignition system.

11. An apparatus for remote operation of an ignition system of a vehicle according to claim 10, wherein said plurality of equipments includes position of gear stick; position of hand brake; position of brake pedal; level of oil in fuel tank; and, level of engine oil.

12. An apparatus for remote operation of an ignition system of a vehicle according to claim 10, wherein said wireless device validates said plurality of equipments using a plurality of sensors.

13. An apparatus for remote operation of an ignition system of a vehicle according to claim 12, wherein said plurality of sensors includes position sensors and level sensors.

14. An apparatus for remote operation of an ignition system of a vehicle according to claim 1, wherein said wireless control device comprises a GPS transmitter.

15. An apparatus for remote operation of an ignition system of a vehicle according to claim 1, wherein said remote communication device further comprises a GPS receiver.

16. An apparatus for remote operation of an ignition system of a vehicle according to claim 15, wherein said GPS transmitter sends out positions of said vehicles.

17. An apparatus for remote operation of an ignition system of a vehicle according to claim 16, wherein GPS receives said positions of said vehicles.

18. An apparatus for remote operation of an ignition system of a vehicle according to claim 16, wherein said user sends said second set of instructions to start a selected vehicle out of said vehicles.

19. An apparatus for remote operation of an ignition system of a vehicle according to claim 1, said apparatus enables said user to operate more than one vehicle using said remote communication device.

20. The method for using an apparatus for remote operation of an ignition system of a vehicle, method comprising steps of:
providing a server;
providing an internet protocol;
providing a wireless control device, wherein said wireless control device operably connects to an ignition system of said vehicle; and,
providing a remote communication device, wherein said remote control device connects to said wireless control device via said internet protocol at said server.

21. The method for using an apparatus for remote operation of an ignition system of a vehicle according to claim 20, wherein said wireless control device executes a set of instructions sent out by said remote communication device.

22. The method for using an apparatus for remote operation of an ignition system of a vehicle according to claim 21, wherein said wireless control device facilitates start of said vehicle in accordance of said set of instructions.
